(19) United States
(12) Patent Application Publication
(10) Pub. No.: US 2026/0252299 A1
(43) Pub. Date: Aug. 27, 2026

(54) APPARATUS OF PROVIDING CONTENTS USING LED BLOCK

(71) Applicant: Jae Young JUNG, Yongin-si (KR)

(72) Inventor: Jae Young JUNG, Yongin-si (KR)

(21) Appl. No.: 19/663,243

(22) Filed: Apr. 29, 2026

Related U.S. Application Data
(63) Continuation-in-part of application No. PCT/KR2023/015711, filed on Oct. 12, 2023.

(30) Foreign Application Priority Data
Nov. 25, 2022 (KR) 10-2022-0159865

(51) Int. Cl. G06F 3/14; G09G 3/20; G09G 3/32

(52) U.S. Cl. CPC G06F 3/1446; G09G 3/2096; G09G 3/32; G09G 2300/026; G09G 2320/0666; G09G 2320/0686; G09G 2340/0492; G09G 2356/00

(57) ABSTRACT

Provided is a content providing device using display blocks that can realize virtually unlimited two-dimensional and three-dimensional content by combining colors and images with the assembly of the display blocks. The device comprises a plurality of display modules and a motion detection unit mounted on a housing, connectors disposed on side surfaces of the housing, and a motion induction unit located above the motion detection unit, wherein the motion induction unit interacts with the motion detection unit to separate the display modules into image modules and background modules.

### TECHNICAL FIELD

The present invention relates to a content providing device, more particularly to a content providing device that is capable of making use of a block assembly in which display blocks (DBs) are joined together to thus provide various content.

### BACKGROUND ART

A block assembly is constructed by joining blocks together in various arrangement methods. For example, block toys that have naturally induced learning to easily and effectively improve language and computing capabilities are disclosed in Korean Patent No. 10-1713085, Korean Patent Application Publication No. 2017-9094, etc. Recently, block toys interworking with Internet of Things (IoT) and short-range communication have been developed for interactive play and creative education that stimulate interest and imagination. With the development of IT technology, further, coding through automation or artificial intelligence of a device becomes enlarged to a general user region from an expert region, and methods of applying such coding to a block assembly have been proposed. Like this, the block assembly is widely appliable in various fields.

Further, display blocks (DBs) emit a plurality of diodes to have excellent distinctiveness at a long distance and provide content with various colors and images so that they are considered as desirable means applicable to the block assembly. If colors and images are combined to the display blocks (DBs) joined together, virtually unlimited and various dimensions of content can be provided. Furthermore, the display blocks (DBs) can be symmetric to coordinates so that they may be used for mathematics education. However, conventional block assemblies are still lacking in proper utilization of various colors and images as the characteristics of the display blocks (DBs).

### Disclosure

### Technical Problem

It is an object of the present invention to provide a content providing device using display blocks (DBs) that is capable of joining the display blocks (DBs) together, while combining colors and images to the display blocks (DBs), thereby providing two-dimensional and three-dimensional content close to infinity.

### Technical Solution

To accomplish the above objects of the present invention, there is provided a content providing device including a housing, a plurality of display modules and a motion detection unit 20 mounted on the housing, connectors 30 disposed on side surfaces of the housing, and a motion induction unit (MI) located above the motion detection unit 20. In this case, the motion induction unit (MI) may approach the motion detection unit 20 to separate the plurality of display modules into image modules 12a and background modules 12b. The separation into image modules 12a and background modules 12b may reduce power consumption by limiting light emission to selected modules.

According to the present invention, the motion detection unit 20 may include any one of a motion sensor, an image sensor, and a combination of the motion sensor and the image sensor. The connectors 30 may serve to provide communication and power supply for the plurality of display blocks (DBs). The plurality of display blocks (DBs) may be linked to a content management app wiredly or wirelessly. The motion induction unit (MI) may induce any one of motions of rotation, movement, distortion, reduction/enlargement, and color/brightness changes of the image modules 12a. The motions of the motion induction unit (MI) may be designated by a tap provided by the content management app or executed through voice recognition.

According to the present invention, the plurality of display blocks (DBs) may be joined together to make any one of a matrix-shaped display block (DB) assembly and a bar-shaped display block (DB) assembly. The matrix-shaped display block (DB) assembly may form a combined image module in which the image modules 12a are connected to one another, and the combined image module may induce any one of motions of rotation, movement, distortion, reduction/enlargement, and color/brightness changes by means of the motion of the motion induction unit (MI).

### Advantageous Effects of Invention

According to the present invention, the content providing device using the display blocks (DBs) can utilize the motions of the motion induction unit (MI) for the motion detection unit 20 to allow colors and images to be combined to the display blocks (DBs), while the display blocks (DBs) are joined together, thereby providing two-dimensional and three-dimensional content close to infinity.

### BRIEF DESCRIPTION OF DRAWINGS

FIG. 1 is a block diagram illustrating a content providing device according to the present invention.

FIG. 2 is a perspective view illustrating an display block (DB) of the content providing device according to the present invention.

FIGS. 3 to 6 are diagrams illustrating examples in which images are converted in the display block (DB) according to the present invention.

FIG. 7 is a diagram illustrating a state where data is acquired and then filtered by means of an operation of a motion induction unit (MI) of the content providing device according to the present invention.

FIGS. 8 to 10 are diagrams illustrating examples in which images are converted in a matrix-shaped display block (DB) assembly according to the present invention.

FIG. 11 is a diagram illustrating an example in which an image is converted in a bar-shaped display block (DB) assembly according to the present invention.

### MODE FOR INVENTION

Hereinafter, preferred embodiments of the present invention will be described in detail with reference to the accompanying drawings. The embodiments described below may be modified into various other forms, and the scope of the present invention is not limited to the embodiments described below. The embodiments of the present invention are provided to more completely explain the present invention to those skilled in the art. In the drawings, the drawings are exaggerated for convenience of description. Meanwhile, terms pointed to a position such as top, underside, front, and the like are merely related to those shown in the drawings. Indeed, an display block (DB) may be used in any optional direction, and the spatial direction when the display block (DB) is actually used varies according to the direction and rotation of the display block (DB).

An embodiment of the present invention suggests a content providing device using display blocks (DBs) (for example, LED blocks) that can utilize motions of a motion induction unit (MI) for a motion detection unit 20 to allow colors and images to be combined to the display blocks (DBs), while the display blocks (DBs) are joined together, thereby providing two-dimensional and three-dimensional content close to infinity. To this end, a method of providing content using the motions of the motion induction unit (MI) for the motion detection unit 20 will be described in detail, and further, an application example of a block assembly to which the motions of the motion induction unit (MI) for the motion detection unit 20 are applied will be explained in detail. The block assembly according to an embodiment of the present invention joins the display blocks (DBs) together in various arrangement methods and is thus applied to a block toy, coding education, mathematics education, language learning, and arts and physical education, etc.

FIG. 1 is a block diagram illustrating a content providing device 100 according to an embodiment of the present invention. However, the figure may not be suggested with any strict meaning, and for convenience of description, components not shown in the drawings may exist.

Referring to FIG. 1, the content providing device 100 includes a content management app (CA) and a plurality of display blocks (DBs), which are operated in a mobile device or PC. In this case, the plurality of display blocks (DBs) are joined together to make an display block (DB) assembly. The content management app (CA) provides content to the display block (DB) assembly and controls additional functions such as motions, communication, a speaker, and the like that are related to the content. The additional functions may include an SW User Interface (UI), an Application Program Interface (API), and other software tools. The content management app (CA) will be described in detail later. The content management app (CA) and the plurality of display blocks (DBs) are interconnected with each other wirelessly (a) or wiredly (b) so that images, sounds, instructions, and the like, as content, may be transmitted. After coding of content is completed, compiled codes are transmitted to the plurality of display blocks (DBs). Hereinafter, the display blocks (DBs) and the display block (DB) assembly will be explained in the mentioned order.

### Display block

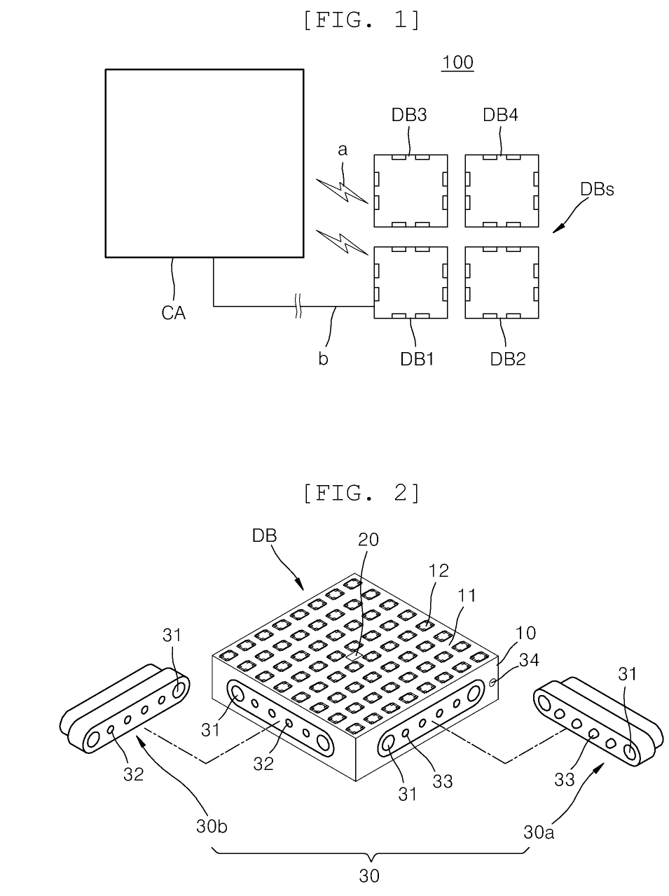

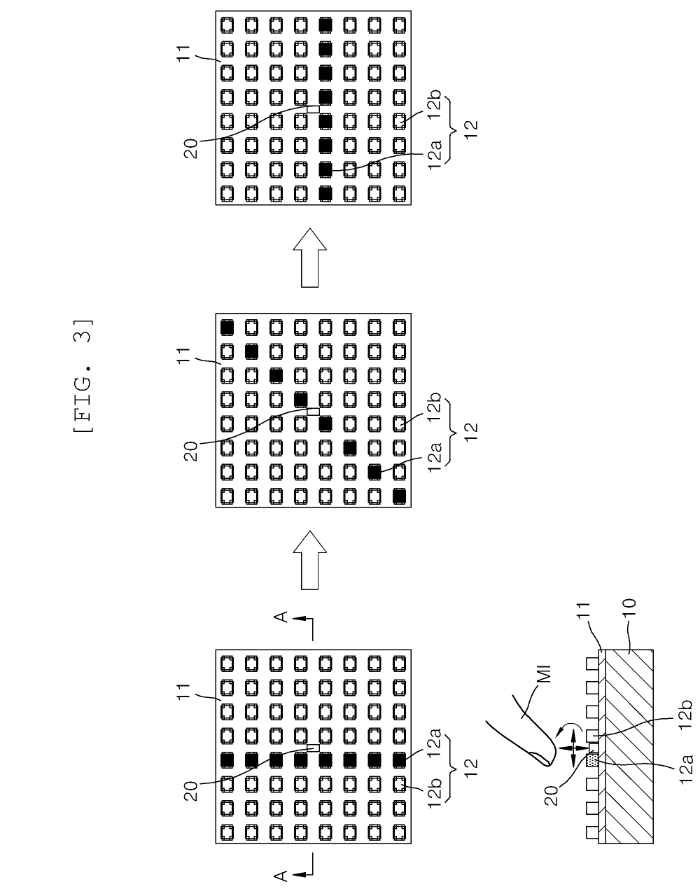

FIG. 2 is a perspective view illustrating the display block (DB) according to the embodiment of the present invention. In this case, the content providing device 100 will be described with reference to FIG. 1.

Referring to FIG. 2, the display block (DB) includes a housing 10, display modules(for example, LED modules) 12, a motion detection unit 20, and connectors 30. Desirably, the housing 10 has the shape of a rectangular parallelepiped, while locating the display modules 12 and the motion detection unit 20 on top thereof and mounting the connectors 30 on side surfaces thereof. The display modules 12 and the motion detection unit 20 are mounted on a substrate 11. Pixel images may be expressed through the display modules 12. Although not shown in the drawings, the display block (DB) may include a sound input/output unit, a vibration motor, a battery, a wireless communication unit, a memory unit (e.g. an SD memory card), etc., and LCD modules as well as the display modules 12 may be used.

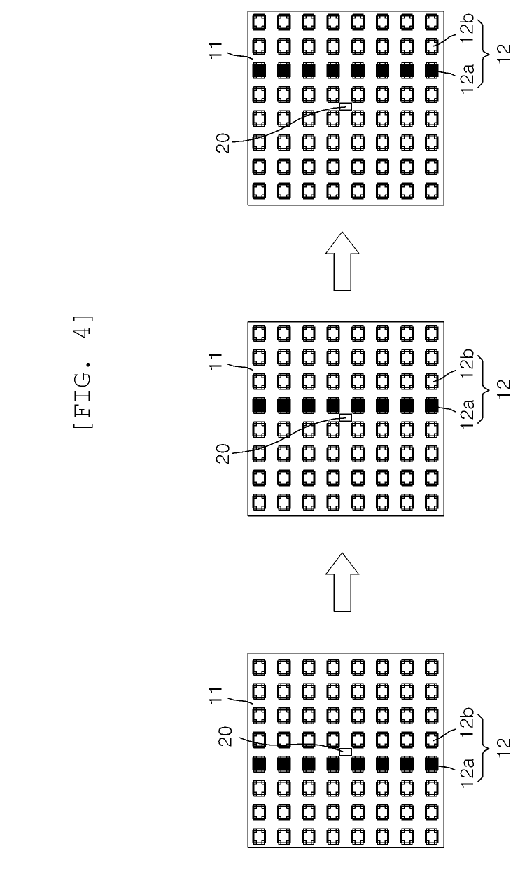

The motion detection unit 20 is formed of any one of a motion sensor, an image sensor, and a combination of the motion sensor and the image sensor. The image sensor may utilize artificial intelligence, for example, a Generative Adversarial Network (GAN), to identify the operation of a motion induction unit (MI) (See FIG. 3) through an image of the motion induction unit (MI) like a finger. If the image sensor is combined with the motion sensor, the operation of the motion induction unit (MI) may be more clearly identified. In this case, to obtain depth information of an object in a 3D space, various methods such as dot structured light and an image sensor, a stereo image sensor, and a multi-point time-of-flight (TOF) may be used. The motion induction unit (MI) as a means for operating the motion detection unit 20 may be variously modified within the scope of the present invention. The motion induction unit (MI) refers to any element that provides an input to the motion detection unit 20. The motion induction unit (MI) may include, for example, a user body part, an external object, or an input device configured to interact with the motion detection unit 20. The motion induction unit (MI) may interact with the motion detection unit 20 through physical proximity, gesture input, or remote input. The motion induction unit (MI) may be located above, adjacent to, or spaced apart from the motion detection unit 20.

All known types of motions sensors may be applied as the motion sensor. In this case, a known three-axis or nine-axis Inertial Measurement Unit (IMU) sensor may be applied. The three-axis inertial measurement unit (IMU) sensor may include a gyro sensor, or the like, and the nine-axis inertial measurement unit (IMU) sensor may include a geomagnetic sensor, a gyro sensor, and an acceleration sensor. The gyro sensor detects rotation angles in directions of three axes (x, y, and z) of the housing 10 and converts the detected rotation angles into electrical signals, and the acceleration sensor detects changes in acceleration in the directions of three axes (x, y, and z) of the housing 10 and converts the detected acceleration changes into electrical signals. The geomagnetic sensor detects the direction of the housing 10. For example, a one or more-point ToF sensor may be applied as the motion sensor.

The connectors 30 are disposed on the side surfaces of the housing 10 and serve to provide communication or power supply or both of communication and power supply. If the connectors 30 serve to provide both of the communication and the power supply, all known methods may be applied to the connectors 30. Herein, one example is suggested. To be specific, each connector 30 has permanent magnets 31 on both sides thereof and a transmission side connector 30a or a reception side connector 30b located inside the permanent magnets 31. The permanent magnets 31 couple the transmission side connector 30a to the reception side connector 30b of the neighboring housing 10. If the transmission side connector 30a and the reception side connector 30b are coupled to each other, transmission side connection terminals 33 and reception side connection terminals 32 are connected to one another. If the transmission side connection terminals 33 and the reception side connection terminals 32 are connected to one another, power supply and wired communication are performed. The housing 10 includes a USB connection hole 34 on one side surface thereof to insert a USB connector for wired communication and power supply thereinto. The connectors 30 may include electrical or magnetic connection structures including permanent magnets 31 and may support power and data communication via wired or wireless communication.

The connectors enable data exchange between adjacent LED blocks, and the exchanged data may be used to control display states of the LED modules. Further, the exchanged data may also be used to determine or synchronize output state based on interactions between adjacent display blocks via the exchanged data.

In this case, if the display block (DB) assembly is connected to the mobile device or PC through the USB connector of one display block (DB), power supply and communication can be provided for all display blocks (DBs) through the connectors 30. The transmission side connection terminals 33 and the reception side connection terminals 32 constituting the transmission side connectors 30a and the reception side connectors 30b are formed of pins and contact grooves. The transmission side connectors 30a and the reception side connectors 30b are alternately disposed on the side surfaces of the housing 10. If the transmission side connectors 30a and the reception side connectors 30b are alternately disposed, the display blocks (DBs) are turned and thus coupled to one another. In the drawing, the transmission side connection terminals 33 are formed of only the pins, and the reception side connection terminals 32 are formed of only the contact grooves. In some cases, however, the transmission side connectors 30a and the reception side connectors 30b on the side surfaces of the housing 10 may be formed of combinations of the pins and the contact grooves. Further, the permanent magnets 31, the power supply unit, the transmission side connectors 30a, and the reception side connectors 30b may be appropriately changed in position. When power is supplied to one display block (DB), the supplied power may be transmitted to one or more other display blocks (DBs) through the connectors 30.

Examples of the configurations of the permanent magnets 31, the power supply unit, the transmission side connection terminals 33, and the reception side connection terminals 33 of the transmission side connectors 30a and the reception side connectors 30b will be explained in detail below.

In the case of a first configuration example, the transmission side connectors 30a and the reception side connectors 30b are located on the side surfaces of the housing 10. Each transmission side connector 30a includes the permanent magnets 31, a transmission terminal, and a power terminal, and each reception side connector 30b includes the permanent magnets 31, a reception terminal, and a power terminal. The connection terminals 33 and 32 including transmission side and reception side permanent magnets are alternately arranged. The permanent magnets 31 have different polarities on both ends of each connector 30, and otherwise, the permanent magnets 31 of each transmission side connector 30a have different polarities from the permanent magnets 31 of each reception side connector 30b. Further, the power terminals may be included or excluded. The transmission side connection terminals 33 and the reception side connection terminals 32 constituting the transmission side connectors 30a and the reception side connectors 30b are formed of the pins or the pins and the contact grooves.

In the case of a second configuration example, one connector that is made by integrating the transmission side connector 30a and the reception side connector 30b with each other is located on each side surface of the housing 10, and the transmission side connection terminals 33 and the reception side connection terminals 32 are formed of the pins or the pins and the contact grooves. A detailed configuration thereof is the same as the first configuration example.

Moreover, the transmission side connectors 30a and the reception side connectors 30b constitute a wireless communication network with the content management app (CA). Although not specifically shown in the drawing, Bluetooth, ZigBee, LoRa, Wi-Fi, UWB, etc. may be installed inside the housing 10 connected to the transmission side connectors 30a and the reception side connectors 30b.

FIGS. 3 to 6 are diagrams illustrating examples in which images are converted in the display block (DB) according to the embodiment of the present invention. In this case, the display block (DB) will be described with reference to FIG. 2. For convenience of explanation, a cross-sectional view taken along line A-A of the display block (DB) is suggested additionally in FIG. 3.

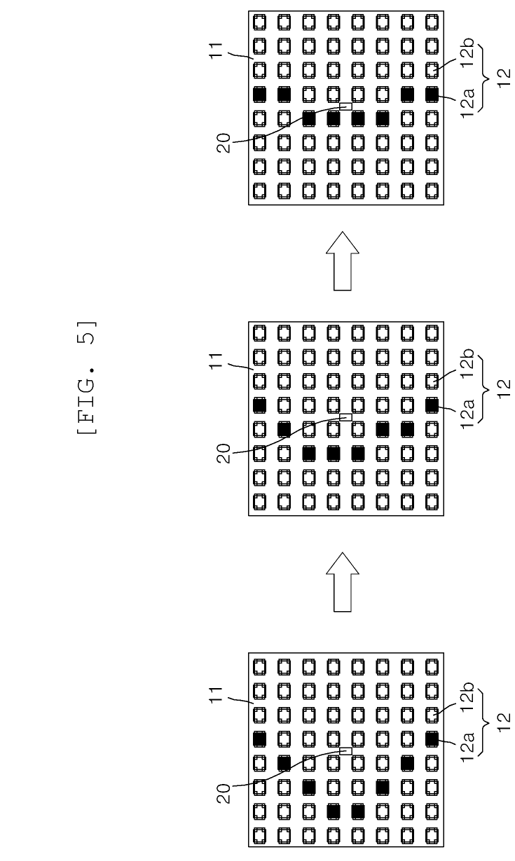

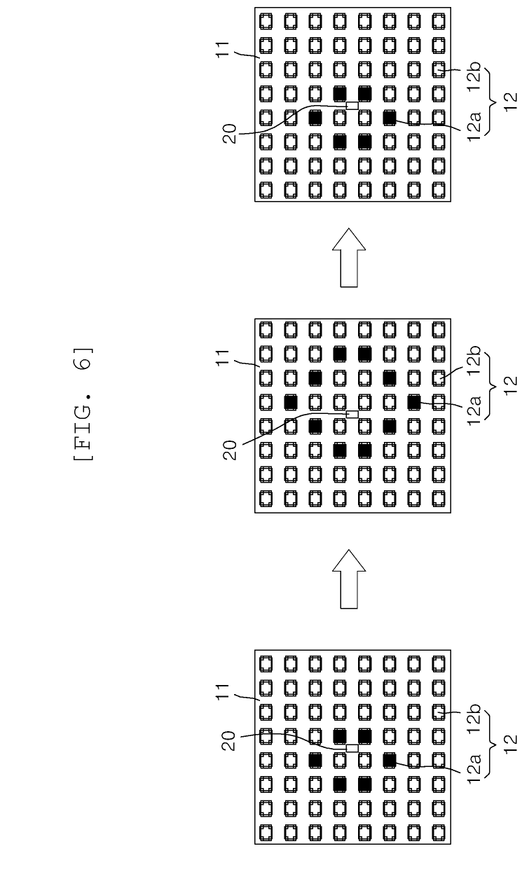

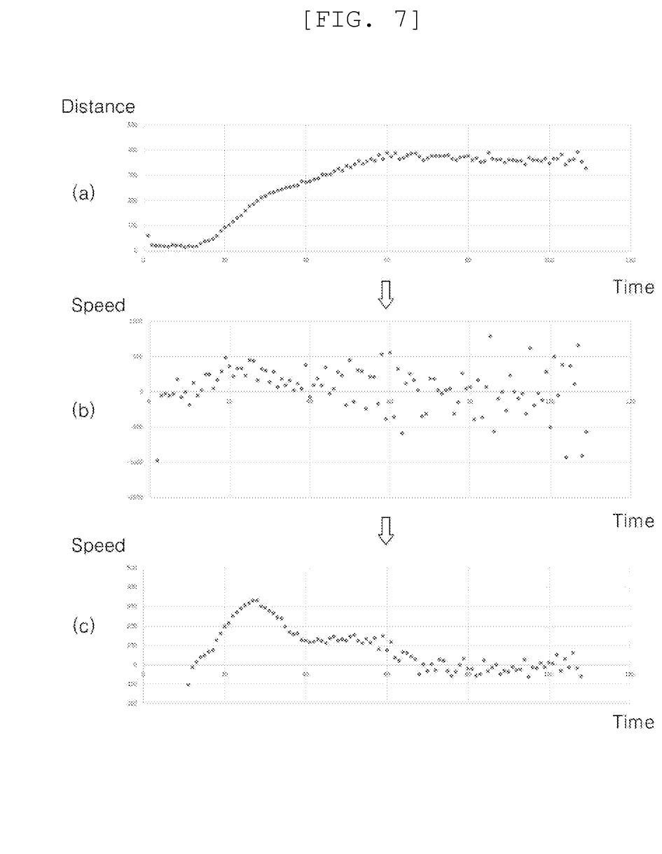

Referring to FIGS. 3 to 6, if the motion induction unit (MI) located above the motion detection unit 20 approaches the motion detection unit 20 of the display block (DB), the display modules 12 are turned on so that they are separated into image modules 12a that represent images and background modules 12b that become a background of the images. When the display modules 12 emit light, they serve as the image modules 12a, and when the display modules 12 are turned off or emit given colors, they serve as the background modules 12b. The motion induction unit (MI) moves toward or away from the motion detection unit 20, moves to the left and right, or holds to rotate the display block (DB). In this case, the left and right movements of the motion induction unit (MI) is possible if an image sensor or multi-point detectable sensor is provided, and the rotation of the display block (DB) through the motion induction unit (MI) is sensible by means of a three or more-axis inertial measurement unit (IMU) sensor. That is, images made by the image modules 12a are converted according to the motions of the motion induction unit (MI). The image conversion includes rotation (See FIG. 3), movement (See FIG. 4), distortion (See FIG. 5), and reduction/enlargement (See FIG. 6), and it further includes color/brightness changes.

In this case, the rotation (FIG. 3), the movement (FIG. 4), the distortion (FIG. 5), the reduction/enlargement (FIG. 6), and the changes in color/brightness of the image modules 12a are designated as a tab provided by the content management app (CA) or executed by voice recognition. To be specific, after the rotation is designated in the tab or if a word ‘rotation’ is pronounced, if the motion induction unit (MI) is moved, rotations of the image modules 12a occur. Further, the motions of the motion induction unit (MI) are dividedly controlled to prevent their combination. For example, in the case of the rotation (FIG. 3), if the motion induction unit (MI) moves to the center of the motion detection unit 20 or rotates in a clockwise direction around the motion detection unit 20, the image modules 12a rotate clockwise, and if the motion induction unit (MI) moves away from the motion detection unit 20 or rotates in a counterclockwise direction around the motion detection unit 20, the image modules 12a rotate counterclockwise. In the case of the movement (FIG. 4), if the motion induction unit (MI) moves to the center of the motion detection unit 20, the image modules 12a move to the left, and if the motion induction unit (MI) moves away from the motion detection unit 20, the image modules 12a move to the right.

In the case of the distortion (FIG. 5), if the motion induction unit (MI) moves to the left, the image modules 12a are distorted in the left direction around a point where the motion induction unit (MI) is located, and if the motion induction unit (MI) moves to the right, the image modules 12a are distorted in the right direction around the point where the motion induction unit (MI) is located. In the case of reduction/enlargement (FIG. 6), if the motion induction unit (MI) is retracted, the image modules 12a are reduced, and if the motion induction unit (MI) spreads, the image modules 12a are enlarged. Like this, if the motion induction unit (MI) is located above the motion detection unit 20 or holds to move the display block (DB), the motions of the motion induction unit (MI) correspond to the rotation (FIG. 3), movement (FIG. 4), distortion (FIG. 5), reduction/enlargement (FIG. 6), and color/brightness changes, so that they induce distinguished image conversion.

FIG. 7 is a diagram illustrating a state where data is acquired and then filtered by means of the operation of the motion induction unit (MI) according to the embodiment of the present invention.

Referring to FIG. 7, if the motion induction unit (MI) moves in front of the motion detection unit 20, a distance value is changed as time passes. In this case, time and distance data are acquired (FIG. 7a), a real-time speed is obtained by differentiating a moving distance (FIG. 7b), and a speed change is obtained more accurately through past data filtering (FIG. 7c). Furthermore, if the graph (FIG. 7c) is further differentiated, acceleration may be obtained. If a one-point distance sensor is applied to the motion detection unit 20, the motion detection unit 20 can sense only a distance to the motion induction unit (MI) therefrom, so that a movement speed and acceleration in one direction can be obtained by using the sensed distance and the time measured inside the display block (DB). This process is an example of distortion utilizing a formula.

If an image sensor or a multi-point detectable distance sensor is applied to the motion detection unit 20, further, the shape, moving direction, speed, and acceleration of the motion induction unit (MI) are obtained. As the shape, moving direction, speed, and acceleration of the motion induction unit (MI) are recognized, the image modules 12a are entirely changed or the color/brightness of each display module 12 are changed. For example, if the motion induction unit (MI) moves fast, the colors/brightness of the display modules 12 at specific positions become light, and contrarily, if it moves slowly, the brightness becomes dark. Further, the movement of the motion induction unit (MI) is detected to differently change the characteristics (e.g. tone, volume, etc. of a musical instrument) of sound.

### Display block assembly

The display block (DB) assembly is made by joining the plurality of display blocks (DBs) together, and it is classified into a matrix-shaped display block (DB) assembly (Sm) and a bar-shaped display block (DB) assembly (Sb). Hereinafter, an operating process and an application example of each display block (DB) assembly will be described. Whether the assembly is completed is determined by setting the assembled shape of the assembly, the number of blocks, and the positions of the display blocks (DBs) through the content management app (CA) of the PC or mobile device, allowing the corresponding information to be transmitted to the display blocks (DBs), joining the display blocks (DBs) together, and checking whether the joined positions and shapes are the same as set in the content management app (CA) through communication. Even if the display blocks (DBs) are not completely joined together, it is possible that the display block (DB) assembly is set to check the joining positions of the display blocks (DBs) by itself and thus to operate the display blocks (DBs).

In the case where the motion detection unit 20 capable of sensing a one-point distance having a high Field of View (FOV) is applied to the display blocks (DBs), if the display blocks (DBs) are joined together to make the display block (DB) assemblies (Sm and Sb), the sensing areas of the intersection areas among the motion detection units 20 of the neighboring display blocks (DBs) are formed. As a result, the distance detection data of the neighboring display blocks (DBs) are shared to obtain the position of the motion induction unit (MI) using a triangulation method. In this case, the position of the motion induction unit (MI) is output to various shapes to the display block (DB) assemblies (Sm and Sb).

Since all of the display blocks (DBs) are capable of detecting a one-point distance, the display block (DB) assemblies (Sm and Sb) can detect a multi-point distance to recognize the shape, moving direction, speed, and acceleration of the motion induction unit (MI), thereby changing the image modules 12a entirely or changing the color/brightness of each display module 12. Further, the display block (DB) assemblies (Sm and Sb) include all functions of the display blocks (DBs) within the scope of the present invention.

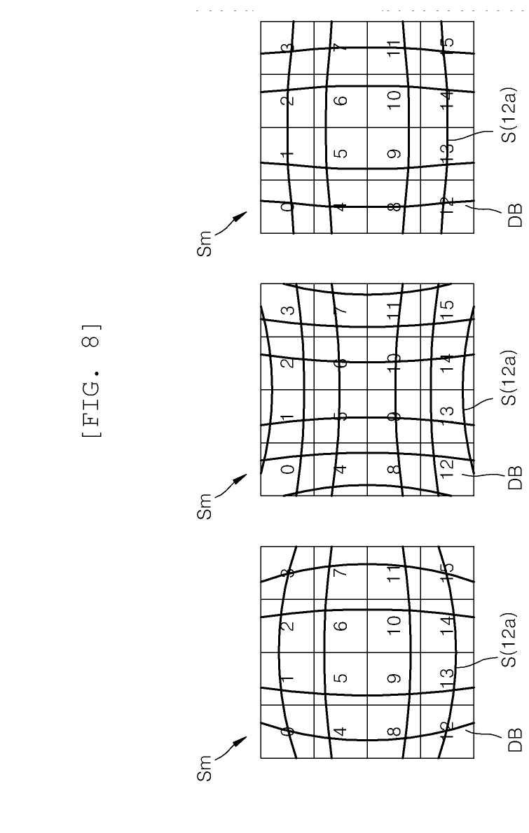

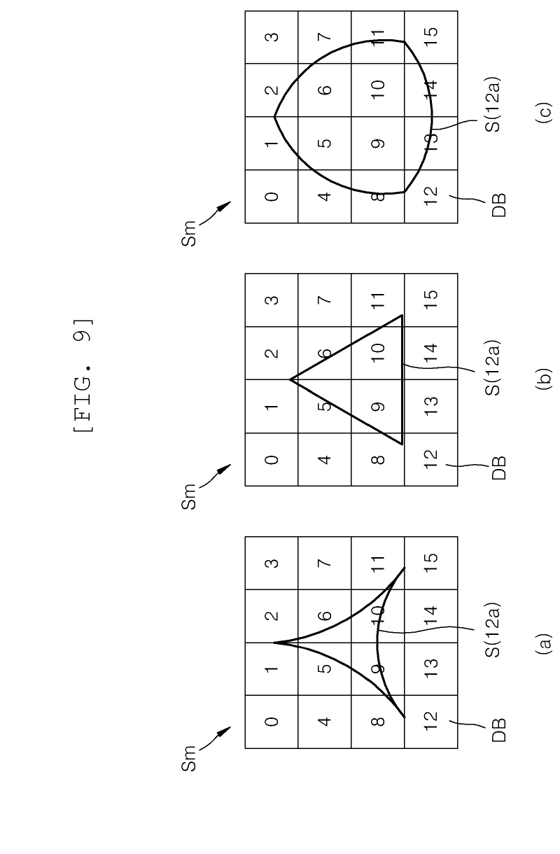

FIGS. 8 to 10 are diagrams illustrating examples in which images are converted in the matrix-shaped display block (DB) assembly (Sm) according to the embodiment of the present invention. In this case, the display block (DB) will be described with reference to FIG. 2. The matrix-shaped display block (DB) assembly (Sm) may be freely utilized to the shape of a polygon such as a square, a rectangle, and the like, and herein, an example of the square display block (DB) assembly is suggested.

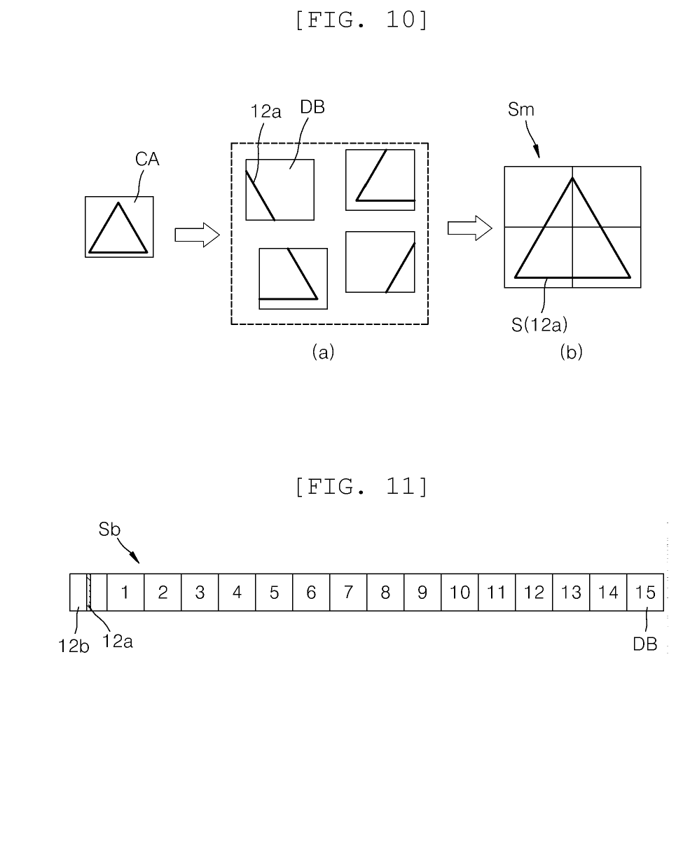

Referring to FIGS. 8 and 9, in the display block (DB) assembly Sm, the image modules 12a in each display block (DB) are linked to one another to provide a combined image module S(12a). In the drawing, the combined image module S(12a) is conceptually represented. In the same manner as the image modules 12a, the combined image module S(12a) is rotated, moved, distorted, reduced/enlarged, and changed in color/brightness. The rotation, movement, distortion, reduction/enlargement, and color/brightness changes of the combined image module S(12a) are designated as a tab provided by the content management app (CA) or executed by voice recognition. To be specific, after the rotation of the combined image module S(12a) is designated by the tab or a word ‘rotation’ is pronounced by voice, if the motion induction unit (MI) is moved, a rotation of the combined image module S(12a) occurs. The plurality of display blocks (DBs) may be configured to cooperate to render visual content as a visually continuous and integrated display.

In this case, an example in which the combined image module S(12a) is made of 16 display modules (DBs) having numbers from 0 to 15 is suggested. In the same manner as the display blocks (DBs), the combined image module S(12a) is rotated by the operation of the motion induction unit (MI) (See FIG. 8). In the same manner as the display blocks (DBs), further, the combined image module S(12a) is distorted by the operation of the motion induction unit (MI) (See FIG. 9). FIG. 9 illustrates an example in which the combined image module S(12a) is distorted. Like this, the combined image module S(12a) may be moved, reduced/enlarged, and changed in color/brightness.

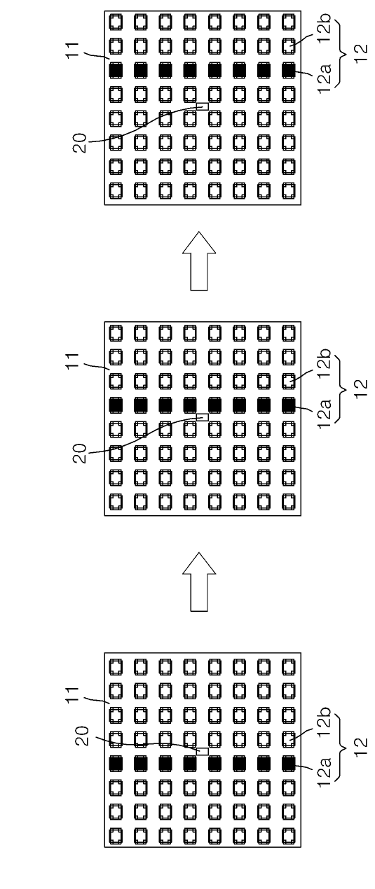

Referring to FIG. 10, an example of the image conversion in the matrix-shaped display block (DB) assembly (Sm) is suggested. If an image is provided by the content management app (CA), the image is dividedly output to the respective display blocks (DBs), and the display blocks (DBs) are joined together to complete the matrix-shaped display block (DB) assembly (Sm) (See FIGS. 10a and 10b). In the process of dividing the image into the respective display blocks (DBs), the image modules 12a as described above are rotated, moved, distorted, reduced/enlarged, and changed in color/brightness by means of the motion induction unit (MI).

FIG. 11 is a diagram illustrating an example in which an image is converted in the bar-shaped display block (DB) assembly (Sb) according to the embodiment of the present invention. In this case, the display blocks (DBs) will be described with reference to FIG. 2.

Referring to FIG. 11, if any one of the plurality of display blocks (DBs) is designated by the motion induction unit (MI), the image module 12a is produced on the corresponding display block (DB). In this case, the image module 12a is produced with various colors. Further, the sound stored in the display block (DB) through the content management app (CA) is produced through a speaker. For example, if the scales of a specific musical instrument are stored in the plurality of display blocks (DBs), the designated display block (DB) emits the corresponding scale through the speaker. If the motion induction unit (MI) moves from the 0^{th} display block (DB) to the 15^{th} display block (DB), a moving speed is obtained through data acquired through the motion detection unit 20. Various changes in color, brightness, and sound are output according to the moving speed. In the matrix-shaped display block (DB) assembly (Sm), of course, different sounds may be output according to the display blocks (DBs).

Although not shown in the drawings, the positions of the display blocks (DBs) may be recognized by means of wireless communication and a positioning method (e.g. triangulation method) such as an artificial satellite even if the display blocks (DBs) are not joined together through the connectors 30, and the image modules 12a and the sounds may be changed according to the corresponding positions of the display blocks (DBs).

The application examples of the display block (DB) assemblies (Sm and Sb) according to the embodiment of the present invention may be proposed freely within the scope of the present invention. Herein, only some examples are presented. The display block (DB) assemblies (Sm and Sb) may provide two-dimensional and three-dimensional content close to infinity by joining the display blocks (DBs) together and combining colors and images to the joined display blocks (DBs).

Although the present invention has been described in detail with reference to preferred embodiments, the present invention is not limited to the above embodiment, and various modifications are possible by a person skilled in the art within the scope of the technical idea of the present invention.

### *Explanations of Reference Numerals

10: housing 11: Substrate

12: display module 12a: Image module

12b: Background module 20: Motion detection unit

30: Connector

30a, 30b: Transmission and reception side connector

31: Permanent magnet

32: Transmission side connection terminal

33 : Reception side connection terminal

34 : USB connection hole

MI: Motion induction unit DB: display block

Sm: Matrix-shaped block assembly

Sb: Bar-shaped block assembly

1. A content providing device comprising:
a plurality of display blocks configured to be coupled to each other,
wherein each of the plurality of display blocks comprises:
a housing;
a plurality of display modules and a motion detection unit mounted on the housing;
connectors disposed on side surfaces of the housing; and
a motion induction unit configured to interact with the motion detection unit,
wherein the motion induction unit interacts with the motion detection unit to induce a change in visual content of the display modules;
and wherein the plurality of display blocks are configured to cooperate to render visual content as a visually continuous and integrated display;
and wherein each of the plurality of display blocks is configured to determine an output state of the display modules based on data received from at least one adjacent display block through the connectors.

2. The content providing device according to claim 1 wherein the output state of each display block is determined based on a relative arrangement of the coupled display blocks.

3. The content providing device according to claim 1 wherein the output state varies depending on a position of each display block within the coupled display blocks.

4. The content providing device according to claim 1 wherein the data received from the adjacent display block includes at least one of content data, positional information, and control signals.

5. The content providing device according to claim 1 wherein the output state includes at least one of visual transformation, color change, brightness change, and motion of displayed content.

6. The content providing device according to claim 1 wherein the change in visual content includes separating the display modules into image modules and background modules.

7. The content providing device according to claim 6, wherein the background modules are configured to emit less light than the image modules.

8. The content providing device according to claim 1 wherein the motion detection unit comprises any one of a motion sensor, an image sensor, and a combination of the motion sensor and the image sensor.

9. The content providing device according to claim 1 wherein the connectors are configured to provide communication and power supply between adjacent display blocks.

10. The content providing device according to claim 1 wherein the plurality of display blocks are configured to exchange content data with an external device.

11. The content providing device according to claim 1 wherein the motion induction unit induces any one of motions of rotation, movement, distortion, reduction/enlargement, and color/brightness changes of the image modules.

12. The content providing device according to claim 1 wherein the motions of the motion induction unit are designated by a tap provided by the content management app or executed through voice recognition.

13. The content providing device according to claim 1 wherein the plurality of display blocks are joined together to make any one of a matrix-shaped display block assembly and a bar-shaped display block assembly.

14. The content providing device according to claim 1 wherein the motion induction unit is configured to induce one or more visual transformations of the display modules, the visual transformations being selected from the group consisting of rotation, translation, deformation, scaling, color change, brightness change, and combinations thereof.

15. The content providing device according to claim 1 wherein power supplied to one display block is distributed to a plurality of other display blocks through the connectors.
